(19) United States
(12) Patent Application Publication
(10) Pub. No.: US 2011/0057932 A1
(43) Pub. Date: Mar. 10, 2011

(54) Holographic Display

(75) Inventors: Robert Missbach, Kreischa/OT Barenklause (DE); Alexander Schwerdtner, Dresden (DE)

(73) Assignee: SeeReal Technologies S.A., Munsbach (LU)

(21) Appl. No.: 12/674,973

(22) PCT Filed: Aug. 29, 2008
(86) PCT No.: PCT/EP2008/061365

§ 371 Date: Feb. 24, 2010

(30) Foreign Application Priority Data
Aug. 31, 2007 (GB) 0716829.7
May 6, 2008 (GB) 0808166.3

(51) Int. Cl. G06T 15/50

(52) U.S. Cl. 345/426

(57) ABSTRACT

A holographic display is provided in which at least one spatial light modulator has a hierarchical structure of the column drivers, the function of the column drivers being distributed to n units which are connected in n cascading stages, where n is two or more, with each successive stage having slower speed circuitry than the previous stage.

### BACKGROUND OF THE INVENTION

1. Field of the Invention

The invention relates to a device including a display on which computer-generated video holograms (CGHs) are encoded. The display generates three dimensional holographic reconstructions.

2. Technical Background

Computer-generated video holograms (CGHs) are encoded in one or more spatial light modulators (SLMs); the SLMs include controllable cells. The cells modulate the amplitude and/or phase of light by encoding hologram values corresponding to a video-hologram. The CGH may be calculated e.g. by coherent ray tracing, by simulating the interference between light reflected by the scene and a reference wave, or by Fourier or Fresnel transforms. An ideal SLM would be capable of representing arbitrary complex-valued numbers, i.e. of separately controlling the amplitude and the phase of an incoming light wave. However, a typical SLM controls only one property, either amplitude or phase, with the undesirable side effect of also affecting the other property. Different ways to modulate the light in amplitude or phase are known, e.g. electrically addressed liquid crystal SLM, optically addressed liquid crystal SLM (OASLM), micro mirror devices or acousto-optic modulators. Prior-art Faraday-effect magneto-optic SLMs (MOSLMs) are known but these only modulate the amplitude of the transmitted light, and have not been used in generating holograms. Such SLMs have been reported by Panorama Labs of Rockefeller Center, 1230 Avenue of the Americas, 7th Floor, New York, N.Y. 10020 USA (www.panoramalabs.com), e.g. in WO2005/076714A2, but other such MOSLMs are also known.

The modulation of the light may be spatially continuous or composed of individually addressable cells, one-dimensionally or two-dimensionally arranged, binary, multi-level or continuous.

In the present document, the term “encoding” denotes the way in which regions of a spatial light modulator are supplied with control values to encode a hologram so that a 3D-scene can be reconstructed from the SLM.

In contrast to purely auto-stereoscopic displays, with video holograms an observer sees an optical reconstruction of a light wave front of a three-dimensional scene. The 3D-scene is reconstructed in a space that stretches between the eyes of an observer and the spatial light modulator (SLM), or possibly even between the eyes of an observer and the space on the side of the SLM opposite to the observer. The SLM can also be encoded with video holograms such that the observer sees objects of a reconstructed three-dimensional scene in front of the SLM and other objects at or behind the SLM.

The cells of the spatial light modulator are preferably transmissive cells which are passed through by light, the rays of which are capable of generating interference at least at a defined position and over a coherence length of a few millimetres or more. This allows holographic reconstruction with an adequate resolution in at least one dimension. This kind of light will be referred to as ‘sufficiently coherent light’.

In order to ensure sufficient temporal coherence, the spectrum of the light emitted by the light source must be limited to an adequately narrow wavelength range, i.e. it must be near-monochromatic. The spectral bandwidth of high-brightness LEDs is sufficiently narrow to ensure temporal coherence for holographic reconstruction. The diffraction angle at the SLM is proportional to the wavelength, which means that only a monochromatic source will lead to a sharp reconstruction of object points. A broadened spectrum will lead to broadened object points and smeared object reconstructions. The spectrum of a laser source can be regarded as monochromatic. The spectral line width of a single-colour LED is sufficiently narrow to facilitate good reconstructions.

Spatial coherence relates to the lateral extent of the light source. Conventional light sources, like LEDs or Cold Cathode Fluorescent Lamps (CCFLs), can also meet these requirements if they radiate light through an adequately narrow aperture. Light from a laser source can be regarded as emanating from a point source within diffraction limits and, depending on the modal purity, leads to a sharp reconstruction of the object, i.e. each object point is reconstructed as a point within diffraction limits.

Light from a spatially incoherent source is laterally extended and causes a smearing of the reconstructed object. The amount of smearing is given by the broadened size of an object point reconstructed at a given position. In order to use a spatially incoherent source for hologram reconstruction, a trade-off has to be found between brightness and limiting the lateral extent of the source with an aperture. The smaller the light source, the better is its spatial coherence.

A line light source can be considered to be a point light source if seen from a right angle to its longitudinal extension. Light waves can thus propagate coherently in that direction, but incoherently in all other directions.

In general, a hologram reconstructs a scene holographically by coherent superposition of waves in the horizontal and the vertical directions. Such a video hologram is called a full-parallax hologram. The reconstructed object can be viewed with motion parallax in the horizontal and the vertical directions, like a real object. However, a large viewing angle requires high resolution in both the horizontal and the vertical direction of the SLM.

Often, the requirements on the SLM are lessened by restriction to a horizontal-parallax-only (HPO) hologram. The holographic reconstruction takes place only in the horizontal direction, whereas there is no holographic reconstruction in the vertical direction. This results in a reconstructed object with horizontal motion parallax. The perspective view does not change upon vertical motion. A HPO hologram requires less resolution of the SLM in the vertical direction than a full-parallax hologram. A vertical-parallax-only (VPO) hologram is also possible but uncommon. The holographic reconstruction occurs only in the vertical direction and results in a reconstructed object with vertical motion parallax. There is no motion parallax in the horizontal direction. The different perspective views for the left eye and right eye have to be created separately.

For a holographic display which can display CGH, an illumination apparatus for providing illumination of a plane area is required, where the illumination has sufficient coherence so as to be able to lead to the generation of a three dimensional image. An example is disclosed in US 2006/250671 for the case of large area video holograms, which is incorporated herein by reference, one example of which is reproduced in FIG. 4. FIG. 4 is a prior art side view showing three focusing elements 1101, 1102, 1103 of a vertical focusing system 1104 in the form of cylindrical lenses horizontally arranged in an array. The nearly collimated beams of a horizontal line light source LS₂ passing through the focusing element 1102 of an illumination unit and running to an observer plane OP are exemplified. According to FIG. 4, a multitude of line light sources LS₁, LS₂, LS₃ are arranged one above another. Each light source emits light which is sufficiently coherent in the vertical direction and which is incoherent in the horizontal direction. This light passes through the transmissive cells of the light modulator SLM. The light is only diffracted in the vertical direction by cells of the light modulator SLM, which are encoded with a hologram. The focusing element 1102 images a light source LS₂ in the observer plane OP in several diffraction orders, of which only one is useful. The beams emitted by the light source LS₂ are exemplified to pass only through the focusing element 1102 of focusing system 1104. In FIG. 4 the three beams show the first diffraction order 1105, the zeroth order 1106 and the minus first order 1107. In contrast to a single point light source, a line light source allows the production of a significantly higher luminous intensity. Using several holographic regions with already increased efficiency and with the assignment of one line light source for each portion of a 3D-scene to be reconstructed, improves the effective luminous intensity. Another advantage is that, instead of a laser, a multitude of conventional light sources, which are positioned e.g. behind a slot diaphragm, which may also be part of a shutter, generate sufficiently coherent light. It will be appreciated by those skilled in the art that the holographic display may take on a range of sizes, according to the application.

In known holographic display panels, the column drivers mainly have the following functions. The column drivers de-multiplex received image data and distribute them on to the individual column wires (see FIG. 1). The column drivers perform a digital-to-analogue (D/A) conversion of the image data and comprise integrated driver transistors which control the column wires. The number of columns which can be controlled at a time per integrated circuit (IC) chip is limited e.g. by the power loss; in known holographic displays this maximum number is about 500 columns. The column drivers are commonly implemented using discrete ICs made of mono-crystalline silicon or thin film transistors (TFTs) made of poly-crystalline silicon (p-Si). For more detailed properties of column drivers in known holographic displays, see Appendix III.

One may compare the relative advantages and disadvantages of TFT and monocrystalline Si (c-Si) technologies. The advantages of the TFT technology include:
No additional costs for the drivers, because they are applied together with the pixel TFTs.
The major portion of the power loss occurs in the many, relatively large TFTs, where the heat can be dissipated easily.
No connection lines between the column drivers and column wires, because the driver transistors are disposed directly next to the column wires.

The disadvantages of the TFT technology include:
Low switching frequency, so that at high column frequencies only very few columns can be multiplexed.
Small widths of structures are not possible.

The advantages of the ICs made of mono-crystalline silicon include:
Very high switching frequencies
Small widths of structures

The disadvantages of the ICs made of mono-crystalline silicon include:
The costs depend on the Si surface area, and since a greater power loss also requires a greater surface area for heat dissipation, the costs go up as the amount of power loss rises.
Additional connection lines between drivers and column wires increase the total line length.
Contacting is difficult and, for example, high pin counts may cause a high scrap rate

3. Discussion of Related Art

WO 2004/044659 (US2006/0055994) filed by the applicant, which is incorporated herein by reference, describes a device for reconstructing three-dimensional scenes by way of diffraction of sufficiently coherent light; the device includes a point light source or line light source, a lens for focusing the light and a spatial light modulator. In contrast to conventional holographic displays, the SLM in transmission mode reconstructs a 3D-scene in at least one ‘virtual observer window’ (see Appendix I and II for a discussion of this term and the related technology). Each virtual observer window is situated near the observer's eyes and is restricted in size so that the virtual observer windows are situated in a single diffraction order, so that each eye sees the complete reconstruction of the three-dimensional scene in a frustum-shaped reconstruction space, which stretches between the SLM surface and the virtual observer window. To allow a holographic reconstruction free of disturbance, the virtual observer window size must not exceed the periodicity interval of one diffraction order of the reconstruction. However, it must be at least large enough to enable a viewer to see the entire reconstruction of the 3D-scene through the window(s). The other eye can see through the same virtual observer window, or is assigned a second virtual observer window, which is accordingly created by a second light source. Here, a visibility region, which would typically be rather large, is limited to the locally positioned virtual observer windows. The known solution reconstructs in a diminutive fashion the large area resulting from a high resolution of a conventional SLM surface, reducing it to the size of the virtual observer windows. This leads to the effect that the diffraction angles, which are small due to geometrical reasons, and the resolution of current generation SLMs are sufficient to achieve a real-time holographic reconstruction using reasonable, consumer level computing equipment.

However, difficulties with the frame rate which can be generated by a holographic display are encountered, especially if more than one viewer of the display is considered. In the hologram-generation approach described in WO 2004/044659 (US2006/0055994), virtual observer windows (VOW) are generated. A reconstructed object can be seen if a VOW is located at an observer's eye. One VOW is needed for each eye of each observer. A high frame rate is required if the VOWs and the colors red (R) green (G) and blue (B) are generated sequentially. “Sequentially” means that light for the colours R, G and B is switched on and off in sequence, and therefore the same SLM cell is used sequentially to encode the R, G and B light for that pixel on the SLM. To avoid the perception of flickering, a frame rate for each eye of at least 30 Hz is necessary. As an example, for 3 observers a frame rate of 30 Hz*2 eyes*3 observers*3 colors=540 Hz is required. This is much faster than the frame rate of liquid crystal (LC)-based-SLMs. Even for a single observer, the implied frame rate of 180 Hz would be at the limits of what can be achieved with existing liquid crystal SLM technology—some display artefacts would occur for fast-changing images. Known fast micro-electromechanical systems (MEMS)-SLM do not provide high-resolution phase modulation. For these technologies, the characteristic switching times are ca. 10 ms for LC and ca. 10 μs for MEMS. Hence known devices have severe difficulty in displaying holographic images to multiple observers with full complex holographic encoding, particularly when the images are in colour. For the case of a single observer, faster frame rates than those obtainable using LC technology would be of benefit, such as in applications with fast-moving action such as in video games, in viewing sporting activities or action films, or in military applications. The MOSLMs reported by Panorama Labs of Rockefeller Center, 1230 Avenue of the Americas, 7th Floor, New York, N.Y. 10020 USA (www.panoramalabs.com), exhibit switching times in the nanosecond regime.

An SLM (including the case of a pair of SLMs in series) that permits independent modulation of amplitude and phase is advantageous for application in a holographic display. A complex-valued hologram has better reconstruction quality and higher brightness than a pure amplitude or a pure phase hologram.

Therefore there is a need for a holographic display device, and for a SLM for a holographic display device, which can accommodate high frame rates, and which can preferably encode phase and amplitude information independently.

Display panels, which have resolutions of up to 3,840×2,400 pixels today, can be controlled by row drivers and column drivers according to the basic principle mentioned above, e.g. with regard to FIG. 1. However, such circuit arrangements become progressively unsuitable for panels with very high resolutions of 2,400×1,600 pixels and above, up to 100 million pixels or more, and with refresh rates of at least 100 Hz. If the number of rows or the refresh rate of a TFT panel is increased, the control frequency on the row wires and column wires will go up as well. This is given by the following equation:

Control frequency=Refresh rate*Number of rows

While this frequency is about 72 kHz in today's panels (assuming 1,200 rows and a refresh rate of 60 Hz), it could easily rise to e.g. at least 1 MHz in the future (assuming for example 6,000 rows and a refresh rate of 180 Hz): an example is given in Appendix III. Increasing the frequency means that the capacity of the column wire and pixel TFTs must be inverted in much shorter intervals. This is why the power loss will rise by the same degree. Because the heat dissipation cannot readily be improved by the same factor as the frequency increase, in discrete driver ICs the number of controlled columns must be reduced by approximately the same factor by which the frequency is increased. Given the same assumptions as above, this means that only 36 instead of 500 columns can be controlled per IC.

Because the number of rows also rises as the resolution is increased, a large number of driver ICs will be necessary. In a display with 16,000 columns, for example, more than 400 driver ICs will be required. Instead of a Si area of about 500 mm², as in today's displays, a Si area of about 20,000 mm² will become necessary. This corresponds with the useful area of a 20 inch diameter Si wafer. It can be perceived easily that this increase in Si area by a factor of 40 will result in a significant rise in costs. Because it is very likely that there will also be reliability problems when equipping 400 ICs, this is not a practical option for high resolutions in combination with high control frequencies.

If the drivers are directly applied on to the glass substrate using the TFT technology, a large number of drivers can be realised without difficulty. However, because of the limited electron mobility in the TFT material used, the switching frequencies of the TFTs are noticeably lower than those of transistors made of monocrystalline silicon. The data rate when transmitting multiplexed image data from the electronics unit of the panel to the drivers made using the TFT technology is confined by the maximum switching frequency. This limit is about 25 MHz today with p-Si.

The maximum switching frequency of the TFTs divided by the control frequency on the column wires is the maximum factor by which the image data can be multiplexed. With high resolutions and high refresh rates, this factor becomes rather small, so that a large number of wires will be required to connect the electronics unit of the panel and the column drivers. This will lead to a very complex electronics module of the panel and to problems with contacting the panel. The two options for implementing the column drivers mentioned above have various disadvantages, which cause severe problems where high-resolution displays are to be controlled at high refresh rates. It is thus simply not feasible to realise a display with 16,000×12,000 pixels and a refresh rate of 180 Hz, i.e. a column control frequency of about 1 MHz, using column drivers commercially available today.

### SUMMARY OF THE INVENTION

In one example, a holographic display is provided in which at least one spatial light modulator has a hierarchical structure of the column drivers, the function of the column drivers being distributed to n units which are connected in n cascading stages, where n is two or more, with each successive stage having slower speed circuitry than the previous stage. In particular, the relative speed of the circuitry of the successive stages is determined by the semiconductor material, e.g. moncrystalline Si as opposed to polycrystalline Si, so that each successive stage having slower speed circuitry is made from a different semiconductor material to the semiconductor material in the previous stage.

In a further example, a holographic display is provided in which at least one spatial light modulator has a hierarchical structure of the column drivers, the function of the column drivers being distributed to two units which are connected in two cascading stages, with each successive stage having slower speed circuitry than the previous stage.

In a further example, a holographic display is provided in which at least one spatial light modulator has a hierarchical structure of the column drivers, the function of the column drivers being distributed to three units which are connected in three cascading stages, with each successive stage having slower speed circuitry than the previous stage.

The holographic display may be one in which the holographic display has two SLMs, which permit independent modulation of phase and amplitude.

The holographic display may be one in which the holographic display has one SLM.

The holographic display may be one in which at least one spatial light modulator with a hierarchical structure of the column drivers is an electrically addressable SLM.

The holographic display may be one in which at least one spatial light modulator with a hierarchical structure of the column drivers is a liquid crystal SLM.

The holographic display may be one in which at least one spatial light modulator with a hierarchical structure of the column drivers is a MOSLM.

The holographic display may be one in which at least one spatial light modulator with a hierarchical structure of the column drivers is an OASLM.

The holographic display may be one in which at least one spatial light modulator with a hierarchical structure of the column drivers is a micro mirror device.

The holographic display may display a computer generated hologram.

The holographic display may produce at least one virtual observer window.

The holographic display may be one in which the higher or the highest speed circuitry is made using InP technology.

The holographic display may be one in which the higher or the highest speed circuitry is made using InSb technology.

The holographic display may be one in which the higher or the highest speed circuitry is made using GaAs technology.

The holographic display may be one in which the higher or the highest speed circuitry is made using SiGe technology.

The holographic display may be one in which the higher speed circuitry is made using c-Si technology.

The holographic display may be one in which the lower speed circuitry is made using c-Si technology.

The holographic display may be one in which the lower or lowest speed circuitry is made using p-Si technology.

The holographic display may be one in which the at least one SLM has a minimum pixel resolution of 2,400×1,600 pixels.

The holographic display may be one in which the at least one SLM has a minimum frame rate of 100 Hz.

The holographic display may be one in which the at least one SLM has greater than 50 million pixels and a frame rate of less than 100 Hz.

The holographic display may be one which is spatially multiplexed, with a frame rate less than 100 Hz, and with a column frequency of 40 kHz or greater.

The holographic display may be one in which a control frequency on the row wires and column wires of the at least one SLM is at least 1 MHz.

The holographic display may be one in which the holographic display has a display panel glass substrate.

The holographic display may be one in which the holographic display panel glass substrate is connected to a panel electronic PCB.

The holographic display may be one in which the holographic display panel glass substrate is connected to a panel electronic PCB, with an intermediate flexible PCB stage.

The holographic display may be one in which the higher or the highest speed circuitry is applied directly on to a glass display panel substrate, using Chip on Glass (COG) technology.

A method is provided of demultiplexing high speed data provided to a holographic display; the holographic display may be one as described above.

### BRIEF DESCRIPTION OF THE DRAWINGS

FIG. 1 is a block diagram of liquid crystal on silicon spatial light modulator circuits, according to the prior art.

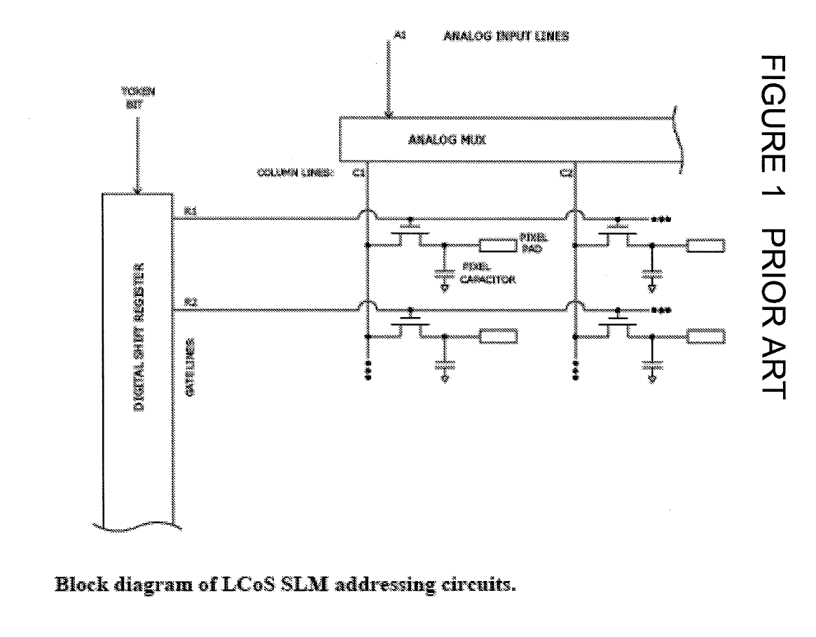

FIG. 2 is a diagram of holographic display column drivers according to the invention.

FIG. 3 is a diagram of holographic display panel connection, according to the invention.

FIG. 4 is a diagram of a holographic display according to the prior art.

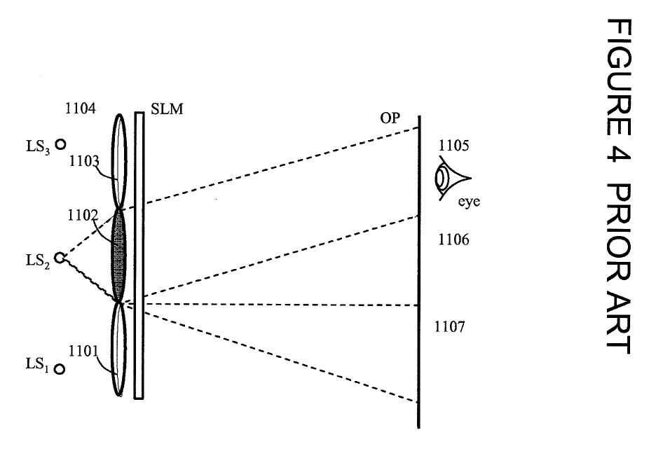

### DETAILED DESCRIPTION

A holographic display is provided with a hierarchical structure of the column drivers of the spatial light modulator. The aim of using a hierarchical structure is to combine the different features of two types of column drivers such that the beneficial aspects of each type of column driver are secured and the disadvantageous aspects of each type of column driver are eliminated. This approach thus provides the prerequisites for controlling holographic display panels with high resolutions and at high refresh rates.

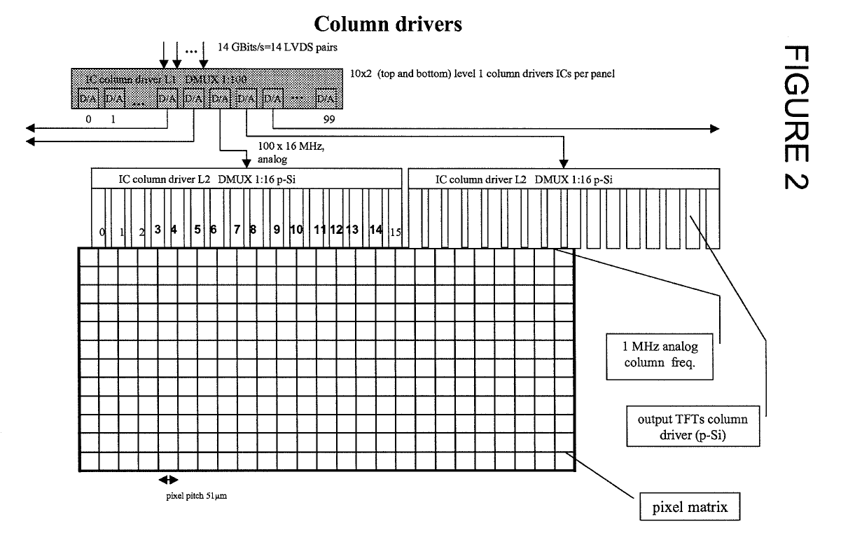

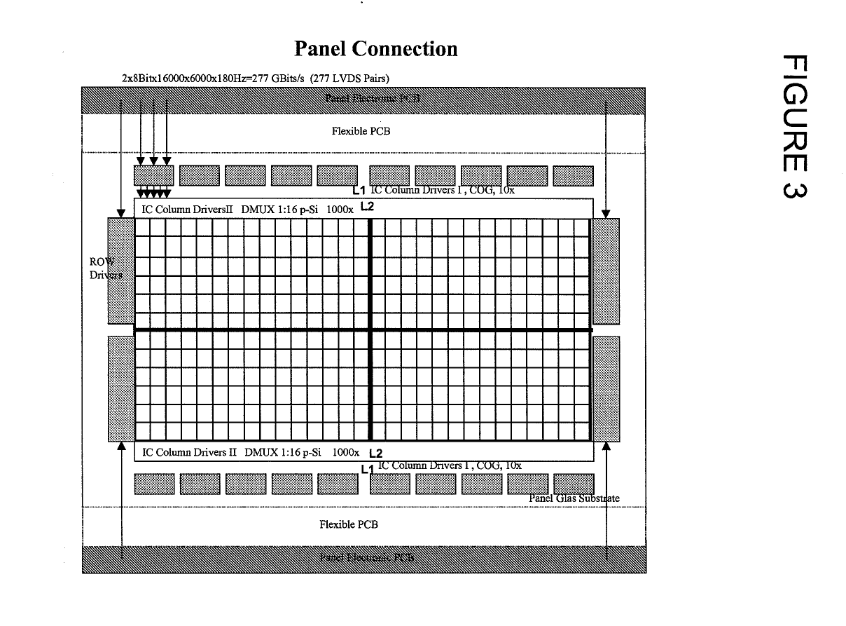

In the hierarchical structure, the function of the column drivers on the spatial light modulator is distributed to two units which are connected in two cascading stages. The first stage (eg. L1 in FIGS. 2 and 3) comprises higher speed circuitry, such as for example ICs made of mono-crystalline silicon (c-Si), or ICs with monocrystalline SiGe layers on a mono-crystalline silicon substrate. The second stage (eg. L2 in FIGS. 2 and 3) comprises lower speed circuitry, such as for example TFT structures on the glass substrate of the panel.

In the first stage, each of a set of discrete ICs receives the image data from the electronics unit of the panel at very high data rates; each discrete IC performs a first de-multiplexing step, and distributes the data further to the second-stage drivers. The data rate during that second transmission is limited by the maximum switching frequency of the subsequent stage.

The D/A converters are preferably incorporated in the first stage, because they comprise a relatively large number of transistors and the area of a transistor is typically much smaller in the higher speed circuitry, eg. in a mono-crystalline silicon unit, than that in lower speed circuitry, eg. in TFT circuitry. Because panels typically have 8 bits per pixel, the D/A conversion alone represents a de-multiplexing by a factor of 8. In a preferred example of the invention, the IC is applied directly on to a glass panel substrate of the display, using Chip on Glass (COG) technology, as shown in FIG. 3.

The second stage is similar to the column drivers made up of TFTs, as commonly used today. Because the frequency on the column wires must be much higher, while the maximum switching frequency of polycrystalline Si (p-Si) in the TFTs remains the same, an analogue input line only allows data for correspondingly fewer columns to be transmitted in a multiplexed form. If a column driver only distributes the analogue signal to 16 columns, for example, a large number of those drivers is required per display. Because those drivers are applied on to the substrate using the TFT technology together with the pixel TFTs, no significant additional effort will become necessary to realise that large number of drivers.

In addition to the analogue inputs, the column drivers of the second stage must have digital inputs for controlling the de-multiplexers. The power transistors used for column control are also TFTs, and they may be disposed directly next to the column wires. In FIG. 2, these are represented by the rectangles numbered 0 to 15 in L2. Although their width is limited by the pixel pitch, the length of the transistors can be increased arbitrarily, so that they have a large surface area and, consequently, heat can easily be dissipated, which is necessary in view of the significant power draw required.

In the example of the invention in FIG. 2, the holographic data display input signal is 14 Gbit/s, transmitted on 14 low-voltage differential signalling (LVDS) pairs. IC column driver stage L1 has a demultiplexing (DMUX) ratio of 1:100, which provides signals to 100 D/A ICs, numbered 0 to 99. There are 20 stage L1 column drivers on the display panel: 10 at the top of the display and 10 at the bottom of the display. Each D/A chip provides an output signal at 16 MHz to the L2 stage IC column drivers. The L2 stage provides a DMUX ratio of 1:16, and thereby provides a 1 MHz analogue column driving signal. The L2 stage is made of p-Si material. A pixel pitch of 51 micrometres is shown in FIG. 2.

FIG. 3 shows holographic display panel connections which are an example of the invention. The total input data rate to the total L1 stage on the top and bottom of the display panel which has 16000 by 6000 pixels in each half (there being top and bottom halves) and is refreshed at 180 Hz is 2×8 bits×16000×6000×180, which is 277 Gbits/s. The input signal is also used to drive the display row drivers. The total panel has 16000 by 12000 pixels. There are 20 stage L1 column drivers on the display panel: 10 at the top of the display and 10 at the bottom of the display, which are mounted using chip on glass technology. The L2 stage provides a DMUX ratio of 1:16. The L2 stage is made of p-Si material. The panel glass substrate may be optionally connected to an intermediate flexible printed circuit board (PCB). The panel glass substrate is connected to a panel electronic PCB, with an optional intermediate flexible PCB stage.

The benefits of a holographic display being provided with a hierarchical structure of the column drivers include:
The major portion of the power loss occurs in the many, relatively large driver TFTs, where the heat can be dissipated easily.
No additional costs for the TFT drivers, because they are applied together with the pixel TFTs.
Only very few connection lines are necessary between the display panel and the electronics unit, which facilitates contacting, but data are transferred at very high rates.
Only very few discrete driver ICs are required.
Because the lines between the drivers of the first and second stage are relatively short, the output transistors of the first stage only need to have a low driver power. This reduces the Si surface area needed and thus the costs.

In a further example of the invention, a hierarchical structure is realised with three stages, with each successive stage having slower speed circuitry than the previous stage. For example, in a zeroth stage, a very high speed circuit may be used. Such a very high speed circuit may be achieved using eg. an IC made of gallium arsenide, indium antimonide or indium phosphide, which have a higher maximum frequency than mono-crystalline silicon, and therefore can receive signals at an even higher data rate. Optical fibre cables or high-speed low-voltage differential signalling (LVDS) pairs can then be used as the signal transfer medium on the input side. There then follow the first and second stages, such as those described above.

In a further example of the invention, a hierarchical structure is realised with n stages, with n greater than three. The first stage has the highest speed circuitry, with each successive stage having slower speed circuitry than the previous stage. Two of the stages may correspond to the first and second stages described above. For example, a first stage comprises indium phosphide circuitry. A second stage comprises SiGe active layers in c-Si circuitry. A third stage comprises c-Si circuitry. A fourth stage comprises p-Si circuitry.

An SLM (including the case of a pair of SLMs in series) that permits independent modulation of amplitude and phase is advantageous for application in a holographic display. A complex-valued hologram has better reconstruction quality and higher brightness than a pure amplitude or a pure phase hologram. The hierarchical structure of column drivers in a holographic display described above may be used in a pair of SLMs, to permit independent modulation of amplitude and phase in a holographic display with high resolution. The SLMs may be LC SLMs, but they may also be SLMs with a faster response time, such as MOSLMs or micro mirror devices SLMs.

The person skilled in the art will appreciate that while holographic displays of the invention require very high resolutions, the column frequency and frame rates may take on a wide range of values depending of the type of holographic display type used. The holographic displays of the invention will provide some benefit even if a slow display with high resolution is used, such as a display with greater than 50 million pixels. Some types of holographic displays do not use time multiplexing to show different views, but use spatial multiplexing instead. These displays can work with very low frame rates (such as less than 100 Hz, or less than 20 Hz) and so even with 4000 (2×2000) rows a column frequency of only 40 kHz can be used.

The holographic displays with the hierarchical structure of column drivers described herein may take on a large range of screen diagonal sizes, such as from one cm or less, for the case of a small mobile phone sub-display, up to a screen diagonal of one metre or more, for the case of a large indoor display intended for viewing by several viewers.

While the applicant's preferred approach to holographic encoding, through the use of virtual observer windows, is described in eg. WO 2004/044659 (US2006/0055994) filed by the applicant which describes a device for reconstructing three-dimensional scenes by way of diffraction of sufficiently coherent light, it should be understood that the holographic display of the invention is not restricted to such an approach, but includes all known holographic display types, as would be obvious to one skilled in the art.

In the Figures herein, the relative dimensions shown are not necessarily to scale.

Various modifications and alterations of this invention will become apparent to those skilled in the art without departing from the scope of this invention, and it should be understood that this invention is not to be unduly limited to the illustrative embodiments set forth herein.

### APPENDIX I

Technical Primer

The following section is meant as a primer to several key techniques used in some of the systems that implement the present invention.

In conventional holography, the observer can see a holographic reconstruction of an object (which could be a changing scene); his distance from the hologram is not however relevant. The reconstruction is, in one typical optical arrangement, at or near the image plane of the light source illuminating the hologram and hence is at the Fourier plane of the hologram. Therefore, the reconstruction has the same far-field light distribution of the real world object that is reconstructed.

One early system (described in WO 2004/044659 and US 2006/0055994) defines a very different arrangement in which the reconstructed object is not at or near the Fourier plane of the hologram at all. Instead, a virtual observer window zone is at the Fourier plane of the hologram; the observer positions his eyes at this location and only then can a correct reconstruction be seen. The hologram is encoded on a LCD (or other kind of spatial light modulator) and illuminated so that the virtual observer window becomes the Fourier transform of the hologram (hence it is a Fourier transform that is imaged directly onto the eyes); the reconstructed object is then the Fresnel transform of the hologram since it is not in the focus plane of the lens. It is instead defined by a near-field light distribution (modelled using spherical wavefronts, as opposed to the planar wavefronts of a far field distribution). This reconstruction can appear anywhere between the virtual observer window (which is, as noted above, in the Fourier plane of the hologram) and the LCD or even behind the LCD as a virtual object.

There are several consequences to this approach. First, the fundamental limitation facing designers of holographic video systems is the pixel pitch of the LCD (or other kind of light modulator). The goal is to enable large holographic reconstructions using LCDs with pixel pitches that are commercially available at reasonable cost. But in the past this has been impossible for the following reason. The periodicity interval between adjacent diffraction orders in the Fourier plane is given by λD/p, where λ is the wavelength of the illuminating light, D is the distance from the hologram to the Fourier plane and p is the pixel pitch of the LCD. But in conventional holographic displays, the reconstructed object is in the Fourier plane. Hence, a reconstructed object has to be kept smaller than the periodicity interval; if it were larger, then its edges would blur into a reconstruction from an adjacent diffraction order. This leads to very small reconstructed objects—typically just a few cm across, even with costly, specialised small pitch displays. But with the present approach, the virtual observer window (which is, as noted above, positioned to be in the Fourier plane of the hologram) need only be as large as the eye pupil. As a consequence, even LCDs with a moderate pitch size can be used. And because the reconstructed object can entirely fill the frustum between the virtual observer window and the hologram, it can be very large indeed, i.e. much larger than the periodicity interval.

There is another advantage as well, deployed in one variant. When computing a hologram, one starts with one's knowledge of the reconstructed object—e.g. you might have a 3D image file of a racing car. That file will describe how the object should be seen from a number of different viewing positions. In conventional holography, the hologram needed to generate a reconstruction of the racing car is derived directly from the 3D image file in a computationally intensive process. But the virtual observer window approach enables a different and more computationally efficient technique. Starting with one plane of the reconstructed object, we can compute the virtual observer window as this is the Fresnel transform of the object. We then perform this for all object planes, summing the results to produce a cumulative Fresnel transform; this defines the wave field across the virtual observer window. We then compute the hologram as the Fourier transform of this virtual observer window. As the virtual observer window contains all the information of the object, only the single-plane virtual observer window has to be transformed to the hologram and not the multi-plane object. This is particularly advantageous if there is not a single transformation step from the virtual observer window to the hologram but an iterative transformation like the Iterative Fourier Transformation Algorithm. Each iteration step comprises only a single Fourier transformation of the virtual observer window instead of one for each object plane, resulting in significantly reduced computation effort.

Another interesting consequence of the virtual observer window approach is that all the information needed to reconstruct a given object point is contained within a relatively small section of the hologram; this contrasts with conventional holograms in which information to reconstruct a given object point is distributed across the entire hologram. Because we need encode information into a substantially smaller section of the hologram, that means that the amount of information we need to process and encode is far lower than for a conventional hologram. That in turn means that conventional computational devices (e.g. a conventional DSP with cost and performance suitable for a mass market device) can be used even for real time video holography.

There are some less than desirable consequences however. First, the viewing distance from the hologram is important—the hologram is encoded and illuminated in such a way that only when the eyes are positioned at the Fourier plane of the hologram is the correct reconstruction seen; whereas in normal holograms, the viewing distance is not important. There are however various techniques for reducing this Z sensitivity or designing around it.

Also, because the hologram is encoded and illuminated in such a way that correct holographic reconstructions can only be seen from a precise and small viewing position (i.e. precisely defined Z, as noted above, but also X and Y co-ordinates), eye tracking may be needed. As with Z sensitivity, various techniques for reducing the X,Y sensitivity or designing around it exist. For example, as pixel pitch decreases (as it will with LCD manufacturing advances), the virtual observer window size will increase. Furthermore, more efficient encoding techniques (like Kinoform encoding) facilitate the use of a larger part of the periodicity interval as virtual observer window and hence the increase of the virtual observer window.

The above description has assumed that we are dealing with Fourier holograms. The virtual observer window is in the Fourier plane of the hologram, i.e. in the image plane of the light source. As an advantage, the undiffracted light is focused in the so-called DC-spot. The technique can also be used for Fresnel holograms where the virtual observer window is not in the image plane of the light source. However, care must be taken that the undiffracted light is not visible as a disturbing background. Another point to note is that the term transform should be construed to include any mathematical or computational technique that is equivalent to or approximates to a transform that describes the propagation of light. Transforms are merely approximations to physical processes more accurately defined by Maxwellian wave propagation equations; Fresnel and Fourier transforms are second order approximations, but have the advantages that (a) because they are algebraic as opposed to differential, they can be handled in a computationally efficient manner and (ii) can be accurately implemented in optical systems.

Further details are given in US patent application 2006-0138711, US 2006-0139710 and US 2006-0250671, the contents of which are incorporated by reference.

### APPENDIX II

Glossary of Terms Used in the Description

Computer Generated Hologram (CGH)

A computer generated video hologram CGH according to this invention is a hologram that is calculated from a scene. The CGH may comprise complex-valued numbers representing the amplitude and phase of light waves that are needed to reconstruct the scene. The CGH may be calculated e.g. by coherent ray tracing, by simulating the interference between the scene and a reference wave, or by Fourier or Fresnel transform.

Encoding

Encoding is the procedure in which a spatial light modulator (e.g. its constituent cells) are supplied with control values of the video hologram. In general, a hologram comprises of complex-valued numbers representing amplitude and phase.

Encoded Area

The encoded area is typically a spatially limited area of the video hologram where the hologram information of a single scene point is encoded. The spatial limitation may either be realized by an abrupt truncation or by a smooth transition achieved by Fourier transform of an virtual observer window to the video hologram.

Fourier Transform

The Fourier transform is used to calculate the propagation of light in the far field of the spatial light modulator. The wave front is described by plane waves.

Fourier Plane

The Fourier plane contains the Fourier transform of the light distribution at the spatial light modulator. Without any focusing lens the Fourier plane is at infinity. The Fourier plane is equal to the plane containing the image of the light source if a focusing lens is in the light path close to the spatial light modulator.

Fresnel Transform

The Fresnel transform is used to calculate the propagation of light in the near field of the spatial light modulator. The wave front is described by spherical waves. The phase factor of the light wave comprises a term that depends quadratically on the lateral coordinate.

Frustum

A virtual frustum is constructed between an virtual observer window and the SLM and is extended behind the SLM. The scene is reconstructed inside this frustum. The size of the reconstructed scene is limited by this frustum and not by the periodicity interval of the SLM.

Light System

The light system may include either of a coherent light source like a laser or a partially coherent light source like a LED. The temporal and spatial coherence of the partially coherent light source has to be sufficient to facilitate a good scene reconstruction, i.e. the spectral line width and the lateral extension of the emitting surface have to be sufficiently small.

Low Voltage Differential Signalling (LVDS)

LVDS is an electrical signalling system that can run at very high speeds over cheap, paired copper cables. It was introduced in 1994, and has since become very popular in computers, where it forms part of very high-speed networks and computer buses. LVDS is a differential signalling system, which means that it transmits two different voltages which are compared at the receiver. LVDS uses this difference in voltage between the two wires to encode the information. The transmitter injects a small current, nominally 3.5 mA, into one wire or the other, depending on the logic level to be sent. The current passes through a resistor of about 100 to 120Ω (matched to the characteristic impedance of the cable) at the receiving end, then returns in the opposite direction along the other wire. From Ohm's law, the voltage difference across the resistor is therefore about 350 mV. The receiver senses the polarity of this voltage to determine the logic level. This type of signalling is called a current loop.

The small amplitude of the signal and the tight electric- and magnetic-field coupling between the two wires reduces the amount of radiated electromagnetic noise.

The low common-mode voltage (the average of the voltages on the two wires) of about 1.25 V allows LVDS to be used with a wide range of integrated circuits with power supply voltages down to 2.5 V or lower. The low differential voltage, about 350 mV as stated above, causes LVDS to consume very little power compared to other systems. For example, the static power dissipation in the LVDS load resistor is 1.2 mW, compared to the 90 mW dissipated by the load resistor for an RS-422 signal. Without a load resistor the whole wire has to be loaded and unloaded for every bit of data. Using high frequencies and a load resistor so that a single bit only covers a part of the wire (while travelling near light speed) is more power efficient.

Periodicity Interval

The CGH is sampled if it is displayed on a SLM composed of individually addressable cells. This sampling leads to a periodic repetition of the diffraction pattern. The periodicity interval is λD/p, where λ is the wavelength, D the distance from the hologram to the Fourier plane, and p the pitch of the SLM cells.

Reconstruction

The illuminated spatial light modulator encoded with the hologram reconstructs the original light distribution. This light distribution was used to calculate the hologram. Ideally, the observer would not be able to distinguish the reconstructed light distribution from the original light distribution. In most holographic displays the light distribution of the scene is reconstructed. In our display, rather the light distribution in the virtual observer window is reconstructed.

Scene

The scene that is to be reconstructed is a real or computer generated three-dimensional light distribution. As a special case, it may also be a two-dimensional light distribution. A scene can constitute different fixed or moving objects arranged in a space.

Spatial Light Modulator (SLM)

A SLM is used to modulate the wave front of the incoming light. An ideal SLM would be capable of representing arbitrary complex-valued numbers, i.e. of separately controlling the amplitude and the phase of a light wave. However, a typical conventional SLM controls only one property, either amplitude or phase, with the undesirable side effect of also affecting the other property.

Virtual Observer Window (VOW)

The virtual observer window is a virtual window in the observer plane through which the reconstructed 3D object can be seen. The VOW is the Fourier transform of the hologram and is positioned within one periodicity interval in order to avoid that multiple reconstructions of the object being visible. The size of the VOW has to be at least the size of an eye pupil. The VOW may be much smaller than the lateral range of observer movement if at least one VOW is positioned at the observer's eyes with an observer tracking system. This facilitates the use of a SLM with moderate resolution and hence small periodicity interval. The VOW can be imagined as a keyhole through which the reconstructed 3D object can be seen, either one VOW for each eye or one VOW for both eyes together.

### APPENDIX III

Sample Properties of Currently Used Column Drivers

Column Drivers in p-Si Technology Directly Connected to the Pixel Matrix as TFTs.
Manufactured together with the TFTs of the pixel matrix
Input: e.g. 24 bit (8 bit per colour) at 5 MHz
Outputs: e.g. 240 columns parallel, analogue at a rate of e.g. 62 kHz (1,024 rows)

Column Drivers as Discrete ICs (Mono-Crystalline Silicon)
About 10 drivers per panel
Input: e.g. 24 bit (8 bit per colour) at 12 MHz
Output: e.g. 480 columns parallel per IC, analogue at e.g. 75 kHz (1,200 rows)

Sample Control Frequencies

Sample values relate to 60 Hz

| No. of rows | Control frequency |
|---|---|
| 1,024 | 61.4 kHz |
| 1,200 | 72 kHz |
| 1,400 | 84 kHz |
| 2,000 | 120 kHz |
| 6,000 | 360 kHz |

Sample values for a display panel with 1,200 rows

| Refresh rate | Control frequency |
|---|---|
| 60 Hz | 72 kHz |
| 120 Hz | 144 kHz |
| 180 Hz | 216 kHz |

Sample calculation for a display panel with 8,000×6,000 pixels and a refresh rate of 180 Hz

Control frequency: 6,000*180 Hz=1.08 MHz

1. A holographic display in which at least one spatial light modulator has a hierarchical structure of the column drivers, the function of the column drivers being distributed to n units which are connected in n cascading stages, where n is two or more, with each successive stage having slower speed circuitry than the previous stage.

2. The holographic display of claim 1, wherein each successive stage having slower speed circuitry is made from a different semiconductor material to the semiconductor material in the previous stage.

3. The holographic display of claim 1, wherein n is three.

4. The holographic display of claim 1, wherein the holographic display has two SLMs, which permit independent modulation of phase and amplitude.

5. (canceled)

6. The holographic display of claim 1, wherein the holographic display has one SLM.

7. The holographic display of claim 1, wherein at least one spatial light modulator with a hierarchical structure of the column drivers is a liquid crystal SLM or wherein at least one spatial light modulator with a hierarchical structure of the column drivers is a micro mirror device or wherein at least one spatial light modulator with a hierarchical structure of the column drivers is an electrically addressable SLM.

8-9. (canceled)

10. The holographic display of claim 7, wherein at least one spatial light modulator with a hierarchical structure of the column drivers is a MOSLM or wherein at least one spatial light modulator with a hierarchical structure of the column drivers is an OASLM.

11. (canceled)

12. The holographic display of claim 1, wherein the holographic display displays a computer generated hologram and wherein the holographic display produces at least one virtual observer window.

13. (canceled)

14. The holographic display of claim 2, wherein the higher or the highest speed circuitry is made using InP technology or is made by using InSb technology, or is made by using GaAs technology, or is made by using SiGe technology.

15-17. (canceled)

18. The holographic display of claim 2, wherein the higher speed circuitry is made using c-Si technology or wherein the lower speed circuitry is made using c-Si technology.

19. (canceled)

20. The holographic display of claim 2, wherein the lower or lowest speed circuitry is made using p-Si technology.

21. The holographic display of claim 1, wherein the at least one SLM has a minimum pixel resolution of 2,400×1,600 pixels.

22. The holographic display of claim 1, wherein the at least one SLM has a minimum frame rate of 100 Hz.

23. The holographic display of claim 1, wherein the at least one SLM has greater than 50 million pixels and a frame rate of less than 100 Hz.

24. The holographic display of claim 1, which is spatially multiplexed, with a frame rate less than 100 Hz, and with a column frequency of 40 kHz or greater.

25. The holographic display of claim 1, wherein a control frequency on the row wires and column wires of the at least one SLM is at least 1 MHz.

26. The holographic display of claim 1, wherein the holographic display has a display panel glass substrate.

27. The holographic display of claim 26, wherein the holographic display panel glass substrate is connected to a panel electronic PCB or wherein the holographic display panel glass substrate is connected to a panel electronic PCB with an intermediate flexible PCB stage.

28. (canceled)

29. The holographic display of claim 14, wherein the higher or the highest speed circuitry is applied directly on to a glass display panel substrate, using Chip on Glass (COG) technology.

30. A method of demultiplexing high speed data provided to a holographic display, the holographic display being one in accordance with claim 1.
